(19) United States
(12) Patent Application Publication
(10) Pub. No.: US 2020/0166774 A1
(43) Pub. Date: May 28, 2020

(54) Temple Bar Cam for Eyeglasses Support

(71) Applicant: Vincent Lee, Lakewood, CA (US)

(72) Inventor: Vincent Lee, Lakewood, CA (US)

(21) Appl. No.: 16/693,140

(22) Filed: Nov. 22, 2019

Related U.S. Application Data
(60) Provisional application No. 62/771,891, filed on Nov. 27, 2018.

(51) Int. Cl. G02C 5/14

(52) U.S. Cl. CPC G02C 5/146

(57) ABSTRACT

A temple bar cam is disclosed that, when used in pairs, sustains a pair of eyeglasses so that the nose pads remain above a wearer's nose. One temple bar cam is placed on each temple bar of a pair of eyeglasses. As the eyeglasses are placed on a wearer's face, the temple bar cams rotate into the user's temples, causing the eyeglasses to cease downward movement and holding the eyeglasses in place just above the user's nose. The temple bar cams may be made of a soft, elastic, and nontoxic material, such as medical grade silicon, for the wearer's comfort. The wearer's comfort is further enhanced by the frustum shape of the temple bar cams, and a bore extending through each temple bar cam in order to increase deformability of the temple bar cam's shape.

### RELATED APPLICATIONS

This application claims the benefit of priority to U.S. Provisional Patent Application Ser. No. 62/771,891 for an invention titled “Temple Bar Cam For Eyeglasses Support” which was filed Nov. 27, 2018, and is currently co-pending.

### FIELD OF THE INVENTION

The present invention pertains generally to a support apparatus for use with eyeglasses. More particularly, the present invention pertains to a cam for holding eyeglasses in place. The Present invention is particularly, but not exclusively, useful as an apparatus to de-weight eyeglasses from pressing against the nose when worn.

### BACKGROUND OF THE INVENTION

Devices for aiding vision have been used since antiquity. In the second century A.D., Ptolemy wrote a treatise on optics, including a description of reflection and refraction, which no longer survives in its original form. Notwithstanding the loss of classical knowledge, some advances in optical science were made in medieval Europe. Translations of Arabic writings further improved the state of the art, and by the late Middle Ages eyeglasses were available in Europe. By about the eighteenth century, eyeglasses began to take the form they have today, in particular with temple bars that extend over the ears to help support the eyeglasses on the wearer's face.

Modern eyeglasses have benefitted from advances in materials science, resulting in lightweight frames and lenses. Nonetheless, eyeglasses still put at least a few ounces of weight on the nose, and regular eyeglass wearers occasionally complain of discomfort, redness, or indentations in the nose as a result of eyeglass wear. Therefore, there remains a need for a device which provides for the use of conventional eyeglasses without the associated discomfort associated with the eyeglasses contact with the wearer's nose.

### SUMMARY OF THE INVENTION

The present invention is directed to a temple bar cam that, when used in pairs, sustains a pair of eyeglasses so that the nose pads of the eyeglasses remain above a wearer's nose. One temple bar cam is placed on each temple bar of a pair of eyeglasses. As the eyeglasses are placed on a wearer's face, the temple bar cams rotate inward and upward into the user's temples, causing the eyeglasses to cease downward movement and hold the eyeglasses in place just above the user's nose. The temple bar cams may be made of a soft, elastic, and nontoxic material, such as medical grade silicon, for the wearer's comfort. Other materials may be used. The wearer's comfort is further enhanced by the conical frustum shape of the temple bar cams, and a bore extending through each temple bar cam in order to increase deformability of the temple bar cam's shape.

In a preferred embodiment, each temple bar cam is configured identically and formed with body having a top opposite a base and a lateral surface connecting the top to the base. In the preferred embodiment, the top, base and lateral surface of the temple bar cam form a conical frustum shape. However, numerous other shapes are available and the conical frustum shape is not intended to be limiting. In a preferred embodiment, the temple bar cam is made of a flexible material, such as medical grade silicon and is further formed with two bores that span the length of the temple bar cam from the front to the base.

The first bore is a temple bar receiver and is formed in the body adjacent the lateral surface. The temple bar receiver is easily deformable and deforms to receive a temple bar of a pair of eyeglasses. Once so deformed, the undeformed portion of the body forms a cam lobe with respect to the deformed temple bar receiver. The cam lobe the deformably rotates with respect to the temple bar receiver when in contact with a temple of user of the eyeglasses. This deformation continues until the pressure exerted on the temple bar cam by the temple and the temple bar receiver when in contact with a temple of the user of the eyeglasses. This deformation continues until the pressure exerted on the temple bar cam by the temple and the temple bar is sufficient to bear the weight of the eyeglasses and avoid contact with the nose.

The second bore is a conical bore in the preferred embodiment and is located substantially along the center of the body. This conical bore assists in the deformation of the cam lobe during use bore has a conical frustum shape analogous to the shape of the body of the temple bar cam in order to maintain relatively even deformability across the length of the temple bar cam.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates a preferred embodiment of a temple bar cam in use with a pair of eyeglasses as worn on a user's face;

FIG. 2 is a cross-sectional view of a temple bar cam against a user's face;

FIG. 3 illustrates a temple bar cam preventing the nose pads of a pair of eyeglasses from resting against a user's nose;

FIG. 4 illustrates the positioning of a temple bar cam between a temple bar and a user's face;

FIG. 5A is a cross-sectional view of a temple bar cam attached to the temple bar of a pair of eyeglasses before the eyeglasses are placed on a user's face;

FIG. 5B is a cross-sectional view of a temple bar cam attached to the temple bar of a pair of eyeglasses as the eyeglasses are being placed on a user's face;

FIG. 5C is a cross-sectional view of a temple bar cam attached to the temple bar of a pair of eyeglasses after the eyeglasses are fully in place on a user's face;

FIG. 6 is a top view of a preferred embodiment of a temple bar cam;

FIG. 7 is a bottom view of a preferred embodiment of a temple bar cam;

FIG. 8 is a right side view of a preferred embodiment of a temple bar cam;

FIG. 9 is a front view of a preferred embodiment of a temple bar cam;

FIG. 10 is a rear view of a preferred embodiment of a temple bar cam;

FIG. 11 is an upper front perspective view of a preferred embodiment of a temple bar cam;

FIG. 12 is a lower rear perspective view of a preferred embodiment of a temple bar cam;

FIG. 13 is a perspective view of an alternative embodiment of a temple bar cam having a cylindrical cam lobe with a protrusion for the temple bar receiver;

FIG. 14 illustrates the temple bar cam of FIG. 13 attached to a temple bar of a pair of glasses;

FIG. 15 is a perspective of an alternative embodiment of a temple bar cam having a hook-shaped cam lobe;

FIG. 16 illustrates the temple bar cam of FIG. 15 attached to a temple bar of a pair of glasses;

FIG. 17 is a perspective view of an alternative embodiment of a temple bar cam having a C-shaped cam lobe;

FIG. 18 illustrates the temple bar cam of FIG. 17 attached to a temple bar of a pair of eyeglasses;

FIG. 19 is a perspective view of an alternative embodiment of a temple bar cam having an L-shaped cross section;

FIG. 20 illustrates the temple bar cam of FIG. 19 attached to a temple bar of a pair of eyeglasses;

FIG. 21 is a perspective view of an alternative embodiment of a temple bar cam having an apostrophe shape;

FIG. 22 illustrates the temple bar cam of FIG. 21 attached to a temple bar of a pair of eyeglasses;

FIG. 23 is a perspective view of an alternative embodiment of a temple bar cam having a shoe shaped cross section;

FIG. 24 illustrates the temple bar cam of FIG. 23 attached to a temple bar of a pair of eyeglasses;

FIG. 25 is a perspective view of an alternative embodiment of a temple bar cam having a continuous bore for receiving a temple bar of a pair of eyeglasses, and formed with a first deformable bore to deform as the temple bar cam is placed against a user's face and formed as a camera receiver which is sized to receive a cylindrical mini-camera;

FIG. 26 illustrates the temple bar cam of FIG. 25 attached to a temple bar of a pair of eyeglasses and showing an insertable mini-camera positioned within the continuous bore;

FIG. 27 is a perspective view of an alternative embodiment of a temple bar cam having a pair of temple bar receivers for receiving a temple bar, and a first deformable bore to deform as the temple bar cam is placed against a user's face, and a second bore formed as a camera receiver sized to receive a cylindrical mini-camera that is positioned away from the user's face and having an increased field of view; and

FIG. 28 illustrates the temple bar cam of FIG. 27 attached to a temple bar of a pair of eyeglasses and showing an insertable mini-camera positioned within the second continuous bore.

### DETAILED DESCRIPTION

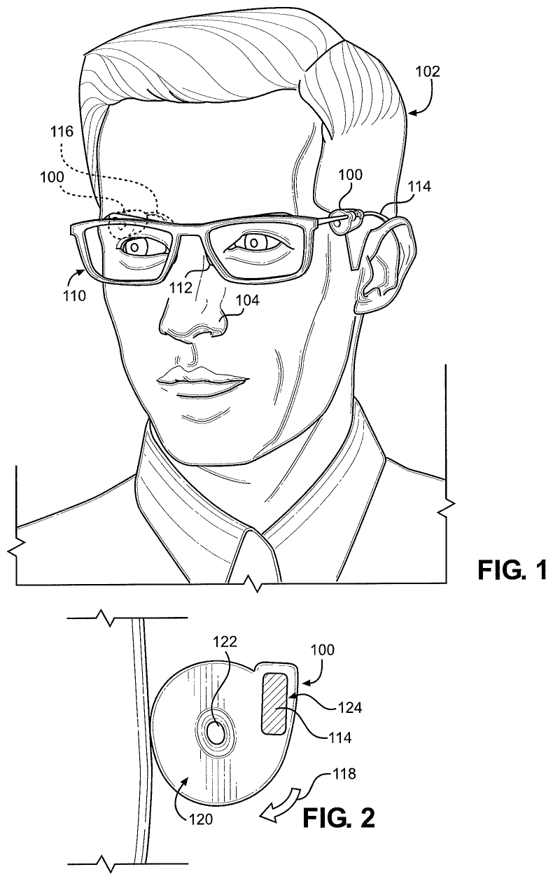

Referring initially to FIG. 1, a pair of temple bar cams 100 is shown in use. An eyeglass wearer (“user”) 102 is illustrated wearing a pair of eyeglasses 110. Although eyeglasses 110 are presented to show the operation of temple bar cams 100, they are depicted in a representative capacity, and temple bar cams may be used with other similarly structured eyewear such as sunglasses, 3D glasses, safety glasses, color corrective glasses, spectacles, and other similar instruments. Eyeglasses 110 typically comprise nose pads 112, which would normally rest against the nose of the user 102, putting a substantial portion of the weight of eyeglasses 110 against the nose 104 of the user 102. However, the left temple bar 114 and the right temple bar 116 each have a temple bar cam 100 attached. Each temple bar cam 100 rests against the sides of the face of the user 102, holding up the eyeglasses 110 so that no weight is put on the nose 104. Since a pair of eyeglasses contains two temple bars, it is normal for two temple bar cams 100 to be used concurrently; one on each temple bar.

In preferred embodiments, temple bar cams 100 are made of silicone rubber, allowing for a high degree of elasticity so that the shape of the temple bar cams 100 can be deformed in use, as described below, and return to their original shape after use. In preferred embodiments the silicone rubber used is a medical grade silicone, allowing them to be used without user 102 discomfort or reactions where the user's skin contacts the temple bar cams 100.

Referring now to FIG. 2, a temple bar cam 100 is depicted in use. Temple bar cam 100 is attached to the left temple bar 114 of eyeglasses 110 (shown in FIG. 1). Broadly, the temple bar can 100 is a deformable body with temple bar receiver 124 which deformably expands to receive a temple bar 114 of a pair of eyeglasses 110. As the left temple bar 114 is passed through the temple bar receiver 124, the body deforms to form lobes 142 and 144 (shown in FIG. 4) adjacent the temple bar receiver 124. The temple bar cam 100 on the right temple bar 116 functions similarly along the right side of the user's 102 face, and so is not depicted separately. Once so deformed, the rest of the body takes on the shape of a cam lobe 120 with respect to the temple bar receiver 124. When eyeglasses 110 are placed on the user's face, a little above the nose 104, temple bar cam 100 deforms in rotational direction 118 as the eyeglasses 110 are connected at the user's ears and lowered toward the user's nose. The rotation, or lowering, of the eyeglasses 110 toward the user's nose causes the cam lobe 120 of temple bar cam 100 to contact the side of the user's face, causing the cam lobe 120 compress in rotational direction 118 until the eyeglasses 110 are secured on the temples of the user by the temple bar cams 100. A conic bore 122 in the temple bar cam 100 allows the temple bar cam 100 to be deformed sufficiently to allow the temple bar cam 100 to rest comfortably between the left temple bar 114 and the face of the user 102.

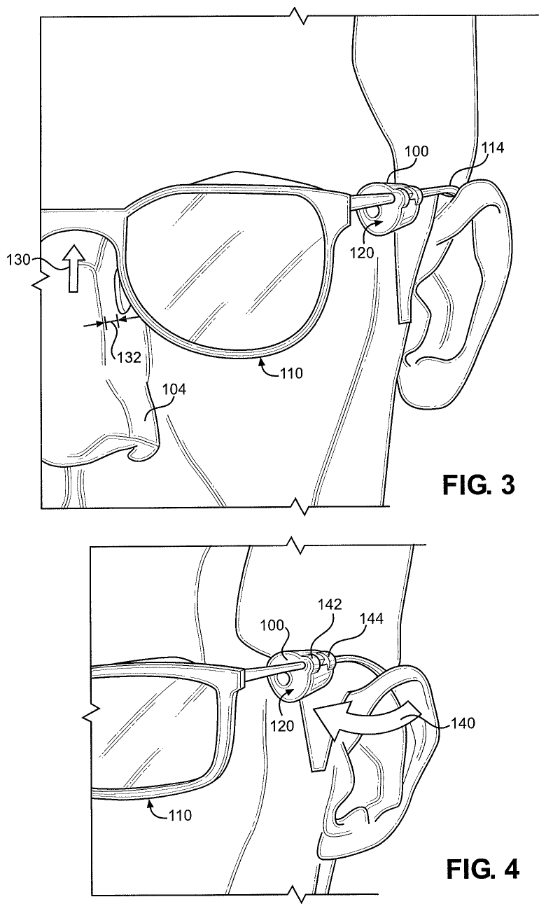

Referring now to FIG. 3, sustained by the pressure placed on the temple bar cam 100 by the left temple bar 114 and the face of the user 102, the temple bar cam 100 is kept in place and in turn holds eyeglasses 110 above the nose 104 of the user 102, as represented by directional arrow 130. This results in a small gap 132 between each nose pad 112 and the nose 104 of the user 102. Thus the nose pad 112 does not put pressure against the nose 104 of the user 102, nor does it cause irritation, redness, or indentations in the nose.

Referring now to FIG. 4, as the eyeglasses 110 are put on, the temple bar cam 100 undergoes a motion illustrated by directional arrow 140 wherein the cam lobe 120 is drawn in between the left temple bar 114 and the side of the face of the user 102. As a result, the eyeglasses 110 are held in place above the position they would otherwise occupy. Also seen in FIG. 4 are lobes 142 and 144 comprising protrusions of portions of temple bar cam 100 created when a temple bar is passed through temple bar receiver 124.

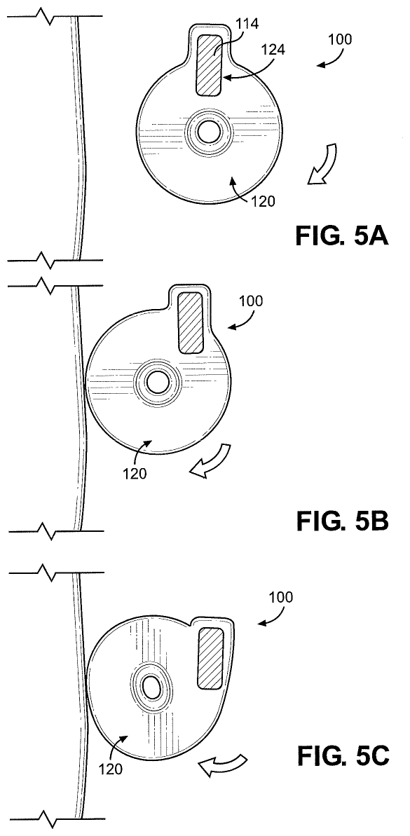

Referring now to FIG. 5A, when a temple bar, illustrated here with left temple bar 114, is passed through the temple bar receiver 124, the temple bar cam 100 assumes a cross-sectional shape with the appearance of a circle having a tail on the side through which the temple bar 114 is passed. The tail corresponds to lobes 142 and 144 seen in FIG. 4. The remaining circular portion of the temple bar cam 100 defines the cam lobe 120 which operates to stop the downward movement of a pair of eyeglasses 110 (shown in FIG. 1).

As shown in FIG. 5B, once the eyeglasses 110 (shown in FIG. 1) are placed on the face of the user 102, and as the eyeglasses 110 begin to be lowered into their resting position, contact between the user's 102 temple and the cam lobe 120 of the temple bar cause the cam lobe 120 to deformably rotate inward toward the face. The inward rotational movement is facilitated by the elasticity of temple bar cam 100, which allows its shape to be deformed somewhat as the temple bar 114 continues its downward motion.

As shown in FIG. 5C, the deformation of the shape of temple bar cam 100 results in the temple bar 114 ultimately being positioned to the side of cam lobe 120 opposite the face of the user 102. The shape of cam lobe 120 is deformed from its original circular shape by the combination of the elasticity of temple bar cam 100 and the presence of conic bore 122 in order to avoid causing discomfort to user 102. At this point, the rotational movement and deformation of cam lobe 120 cease, and the temple bar 114 no longer continues its downward movement, but is held in place by temple bar cam 100 with no contact to the nose.

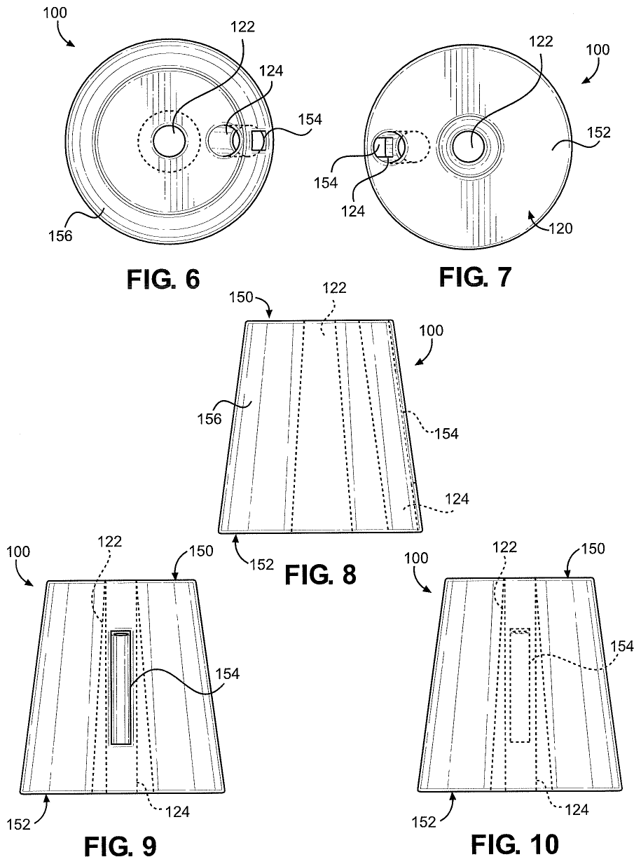

Referring now to FIG. 6, a preferred embodiment of the temple bar cam 100 has a conical frustum shape wherein the upper base or “top” 150 (shown in FIG. 8) is smaller in diameter than the lower base or “base” 152 (shown in FIG. 7), and a circular cross section when not on a temple bar. This conical frustum shape ensures contact between the temple bar cam 100 and the temple of the user 102 along the entire length of the temple bar cam 100. Conic bore 122 and temple bar receiver 124 extend from the top 150 to the base 152, and in some embodiments are formed as part of an injection molding process in which temple bar cam 100 is made, while in other embodiments they are cut into temple bar cam 100 after initial manufacturing of the conical frustum shape.

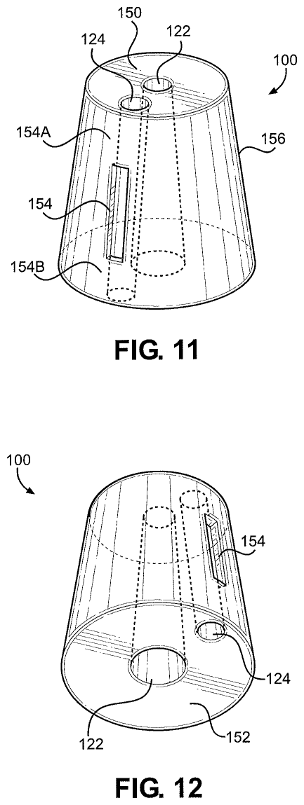

In addition to conic bore 122 and temple bar receiver 124, an aperture 154 extends from the lateral surface 156 to the temple bar receiver 124 in preferred embodiments. In a preferred embodiment, aperture 154 has a rectangular shape, but other shapes can be used without departing from the present invention. The presence of aperture 154 forms two bands 154A and 154B (shown in FIG. 11) which are elastic and capable of positioning over a temple bar. The aperture facilitates the positioning of the temple bar into the temple bar receiver 124 of the temple bar cam 100.

Referring now to FIG. 7, a bottom view of the temple bar cam 100 of FIG. 6 is illustrated, showing base 152 and conic bore 122 and temple bar receiver 124. As shown in FIG. 7, conic bore 122 is also frustum-shaped in a preferred embodiment, having a narrow end at the top 150 (shown in FIG. 8) of the temple bar cam 100, and a wide end at the base 152 of the temple bar cam 100.

Referring now to FIG. 8, a right-side view of the temple bar cam 100 of FIG. 6 is illustrated, showing the tapering of lateral surface 156 from the base 152 to the top 150. Conic bore 122 is not visible from this perspective, but is shown in broken lines by which it can also be seen to taper from the base 152 of the temple bar cam 100 to the top 150, while temple bar receiver 124, in a preferred embodiment, maintains its diameter throughout.

In order to use the temple bar cam 100, a temple bar of eyeglasses 110 (shown in FIG. 1) is placed through the temple bar receiver 124, entering at the base 152 and exiting through the top 150 so that when the eyeglasses 110 are worn, the base 152 is toward the front of the face of the user 102 (shown in FIG. 1).

Referring now to FIG. 9, a front view of the temple bar cam 100 of FIG. 6 is illustrated, showing the rectangular aperture 154. Unlike conic bore 122 and temple bar receiver 124 (shown in FIG. 7), aperture 154 does not extend from base 152 to top 150; rather, it is substantially centered between base 152 and top 150. This results in the formation of lobe 142 and lobe 144 (shown in FIG. 4) as portions of the lateral surface 156 (shown in FIG. 7) above and below rectangular aperture 154 are pushed outward when a temple bar is passed through temple bar receiver 124.

Referring now to FIG. 10, a rear view of the temple bar cam 100 of FIG. 6 is shown. Rectangular aperture 154 is shown in a broken line since it reaches only to temple bar receiver 124 (shown in FIG. 7) and is therefore not visible from the opposite side of the temple bar cam 100.

Referring now to FIG. 11, an upper-front perspective view of the temple bar cam 100 of FIG. 6 is shown. Here, the frustum shape of temple bar cam 100 is clearly visible, while the broken line disclosure shows the frustum shape of conic bore 122. On the other hand, the shape of temple bar receiver 124 is cylindrical. More particularly, in a preferred embodiment, temple bar receiver 124 is an oblique cylinder that maintains a constant distance between the center of its cross-sectional circle and the nearest edge of lateral surface 156. Top 150 is visible in FIG. 11, showing the upper openings of conic bore 122 and temple bar receiver 124, which are of roughly similar size.

Referring now to FIG. 12, a lower-rear perspective view of the temple bar cam 100 of FIG. 6 is shown. Base 152 is visible, as are the lower openings of conic bore 122 and temple bar receiver 124. It can be seen that the lower opening of conic bore 122 is noticeably larger than the lower opening of temple bar receiver 124 due to the former's frustum shape.

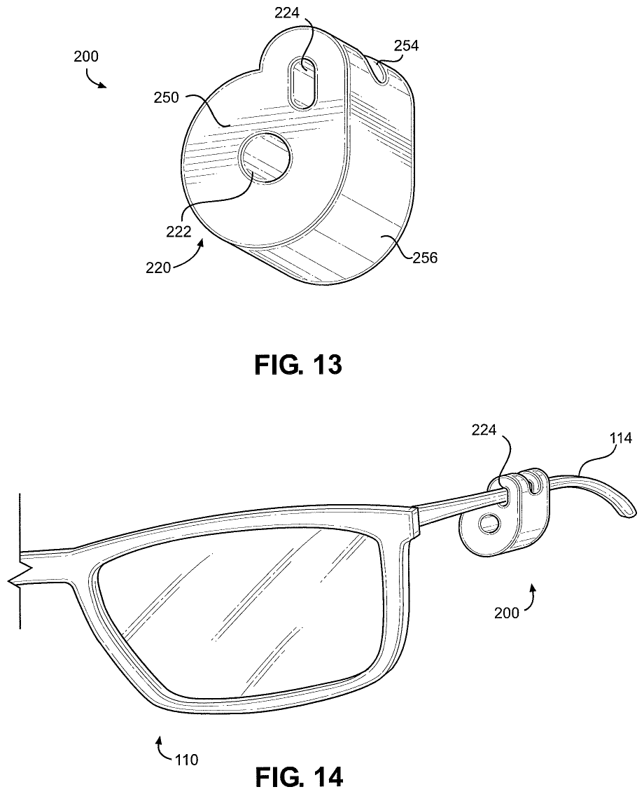

Referring now to FIGS. 13 through 24, alternative embodiments of the temple bar cam have different shapes, which cause the temple bar cam to differ in varying degrees in how easily and how much the shape deforms. Both the deforming characteristics and the shape itself cause the temple bar cam to rest differently against a user's face. A particular user may therefore prefer a specific embodiment over others.

Referring now to FIG. 13, an alternate embodiment of a temple bar cam is shown and generally designated 200. Temple bar cam 200 has a substantially cylindrical cam lobe 220 with a cylindrical bore 222 through its center. A temple bar receiver 224 with an oval-like cross-section creates a protrusion from the cylinder shape of the cam lobe 220. The top surface 250 of temple bar cam 200 is substantially similar in appearance to its bottom surface (not shown), and both cylindrical bore 222 and temple bar receiver 224 extend from the top surface 250 to the bottom surface. An aperture 254 on the lateral surface 256 of the temple bar cam 200 is positioned over the protrusion and extends to the interior of temple bar receiver 224.

Referring now to FIG. 14, temple bar cam 200 is used by placing a temple bar of a pair of eyeglasses 110 through the temple bar receiver 224. As in other embodiments, when the eyeglasses are worn by a user, the cam lobe 220 (shown in FIG. 13) rotates inward and presses into the side of a user's face, preventing the eyeglasses from resting against the user's nose.

As shown in FIG. 14, eyeglasses 110 may be manufactured without any nose pad (112 shown in FIG. 1) because the weight of the eyeglasses is supported exclusively by the temple bar cam on the side of the user's face and the temple bar extending over the ear. This avoids any contact between the eyeglasses and front portion of a user's face, and particularly avoids any contact with the user's nose.

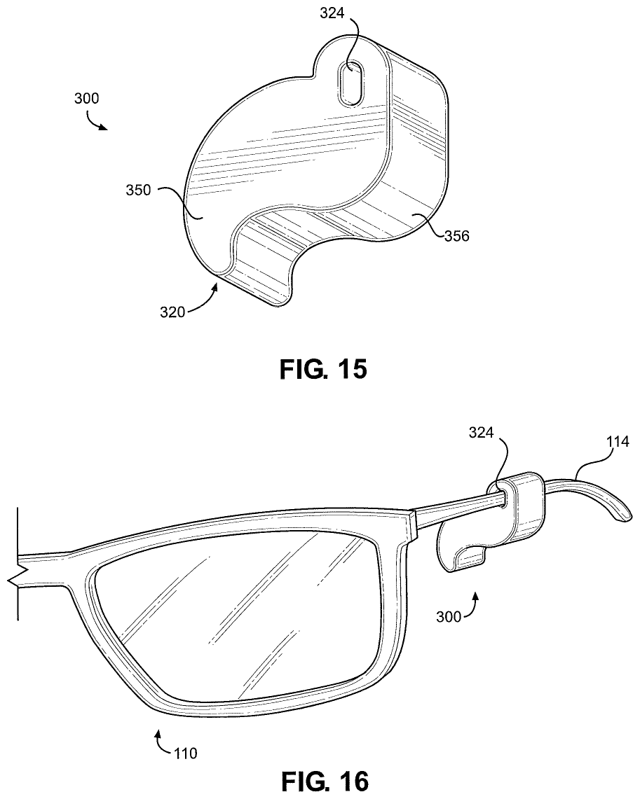

Referring now to FIG. 15, an alternate embodiment of a temple bar cam is shown and generally designated 300. Cam lobe 320 of temple bar cam 300 does not have a hole through it, but the hook or beak shape of cam lobe 320 provides a concave surface which provides a similar flexibility to that which conic bore 122 provides to temple bar cam 100 (shown in FIG. 2) and cylindrical bore 222 provides to temple bar cam 200 (shown in FIG. 13). A temple bar receiver 324 is located at a protrusion from the beak shape of cam lobe 320, and, as with other embodiments, is a hole extending from the top surface 350 of the temple bar cam 300 to the bottom surface (not shown). Temple bar cam 300 also has a lateral surface 356.

Referring now to FIG. 16, temple bar cam 300 is used by placing a temple bar of a pair of glasses 110 through the temple bar receiver 324. As in other embodiments, when the eyeglasses are worn by a user, the cam lobe 320 rotates inward and presses into the side of a user's face, preventing the eyeglasses from resting against the user's nose.

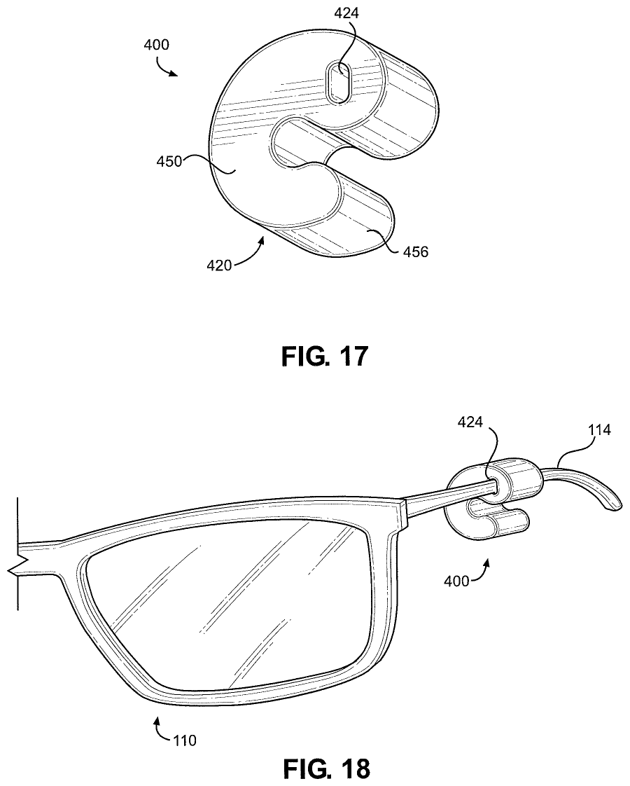

Referring now to FIG. 17, an alternate embodiment of a temple bar cam is shown and generally designated 400. In temple bar cam 400, cam lobe 420 extends away from temple bar receiver 424 in a C-shape. Top surface 450 and a substantially similar bottom surface reflect the C-shaped cross section, surrounded by lateral surface 456. As with other embodiments, temple bar receiver 424 extends all the way through temple bar cam 400, from top surface 450 to the bottom surface (not shown). The concave interior of the C-shaped cam lobe 420 provides a degree of flexibility for deformation of the temple bar cam 400 when in use.

Referring now to FIG. 18, temple bar cam 400 is used by placing a temple bar of a pair of eyeglasses 110 through the temple bar receiver 424. As in other embodiments, when the eyeglasses are worn by a user, the cam lobe 420 rotates inward and presses into the side of a user's face, preventing the eyeglasses from resting against the user's nose.

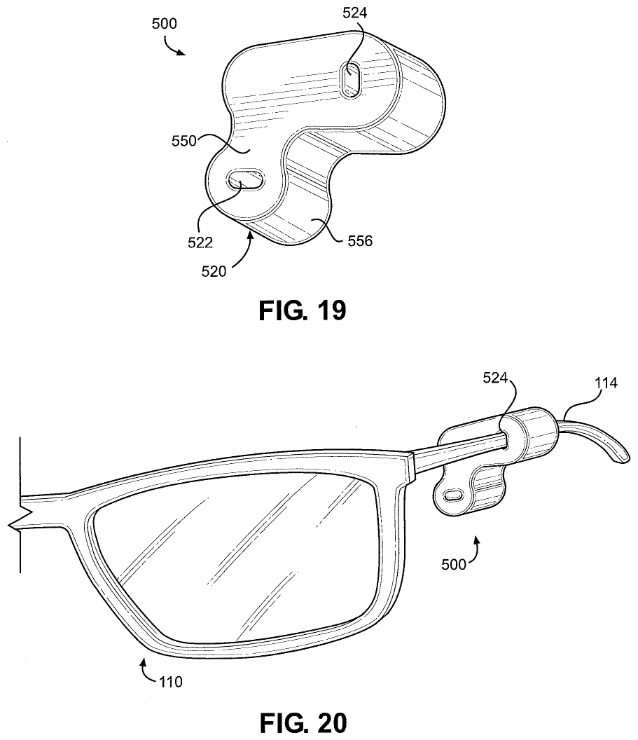

Referring now to FIG. 19, an alternate embodiment of a temple bar cam is shown and generally designated 500.

Temple bar cam 500 is L-shaped. The letter “L” is made of a vertical line segment, or “stem,” with a horizontal line segment, or “leg,” orthogonal to the stem and extending to the right beginning at the bottom terminus of the stem. The leg almost always has a shorter length than the stem, and the corresponding parts of temple bar cam 500 are no exception. In FIG. 19, temple bar cam 500 is shown with the stem horizontal, as if the “L” were rotated ninety (90) degrees clockwise. The endpoint of the stem, the endpoint of the leg, and the intersection of the stem and leg are all rounded. The leg has concave sides between the intersection and endpoint.

Bore 522 is located proximate the endpoint of the stem, and temple bar receiver 524 is located proximate the endpoint of the leg. Both bore 522 and temple bar receiver 524 extend from top surface 550 to the bottom surface of the temple bar cam 500. Lateral surface 556 extends around the perimeter of the L shape.

In temple bar cam 500, bore 522 is shaped like temple bar receiver 524, allowing the user some flexibility as the roles of bore 522 and temple bar receiver 524 may be reversed. More particularly, depending on the user's preference, the user may decide to place a temple bar through bore 522 rather than temple bar receiver 524, providing a different feel for the user when temple bar cam 500 is in use.

Referring now to FIG. 20, temple bar cam 500 is used by placing a temple bar of a pair of eyeglasses 110 through the temple bar receiver 524. Alternatively, the temple bar may be passed through bore 522. As in other embodiments, when the eyeglasses are worn by a user, the cam lobe rotates inward and presses into the side of a user's face, preventing the eyeglasses from resting against the user's nose. The portion of temple bar 500 that functions as the cam lobe differs depending on whether the temple bar is passed through temple bar receiver 524 or bore 522. When the temple bar is passed through temple bar receiver 524, the leg functions as the cam lobe. However, when the temple bar is passed through bore 522, the stem functions as the cam lobe. As in other embodiments, when the eyeglasses are worn by a user, the cam lobe rotates inward and presses into the side of a user's face, preventing the eyeglasses from resting against the user's nose.

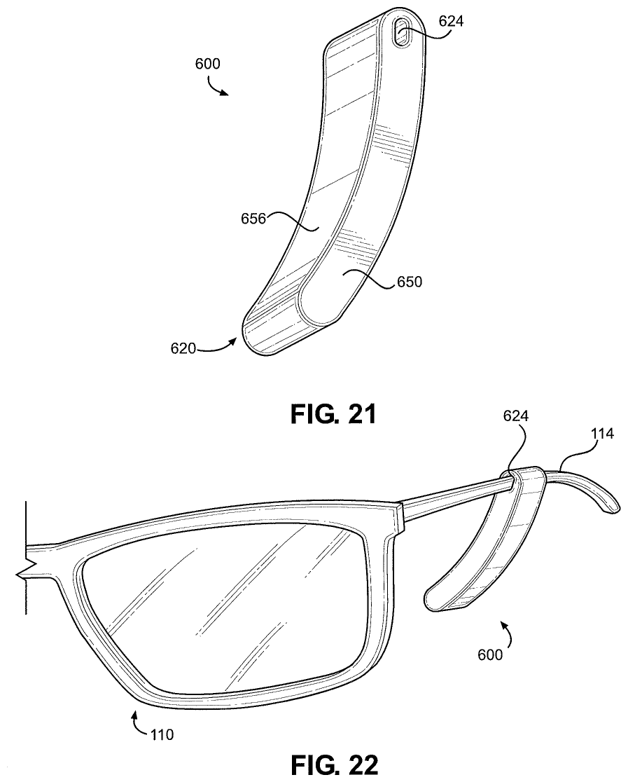

Referring now to FIG. 21, an alternate embodiment of a temple bar cam is shown and generally designated 600. Temple bar cam 600 has a long, slightly curved cam lobe 620. Temple bar receiver 624 extends from top surface 650 to the bottom surface of temple bar cam 600. Lateral surface 656 surrounds the perimeter of temple bar cam 600 between the top surface 650 and bottom surface (not shown).

Referring now to FIG. 22, temple bar cam 600 is used by placing a temple bar of a pair of eyeglasses 110 through the temple bar receiver 624. As in other embodiments, when the glasses are worn by a user, the cam lobe 620 rotates inward and presses into the side of a user's face, preventing the eyeglasses from resting against the user's nose.

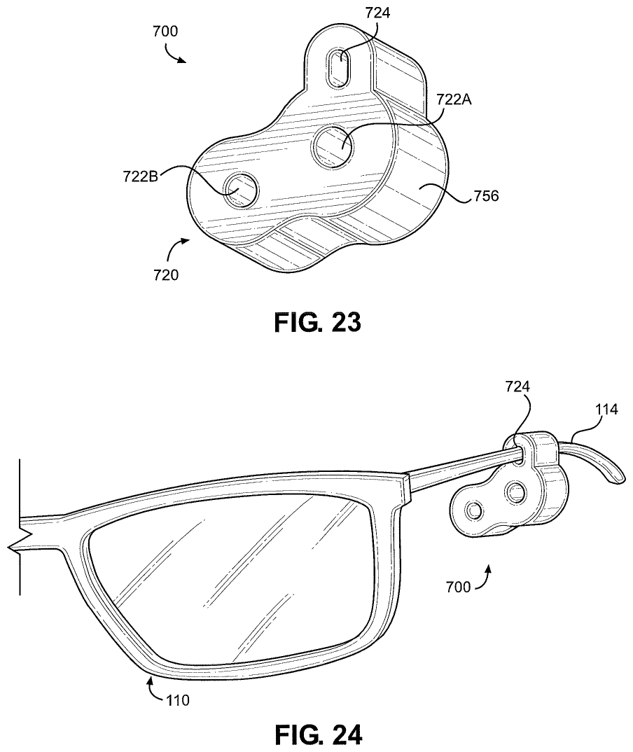

Referring now to FIG. 23, an alternate embodiment of a temple bar cam is shown and generally designated 700. Temple bar cam 700 has a shoe shaped cross section, with two bores 722A and 722B in cam lobe 720, which forms the body of the shoe shape, and temple bar receiver 724 in the collar of the shoe shape. Bores 722A and 722B and temple bar receiver 724 extend from top surface 750 to the bottom surface of temple bar cam 700. Lateral surface 756 surrounds the perimeter of the shoe shape.

Referring now to FIG. 24, temple bar cam 700 is used by placing a temple bar of a pair of eyeglasses 110 through the temple bar receiver 724. As in other embodiments, when the eyeglasses are worn by a user, the cam lobe 720 rotates inward and presses into the side of a user's face, preventing the eyeglasses from resting against the user's nose.

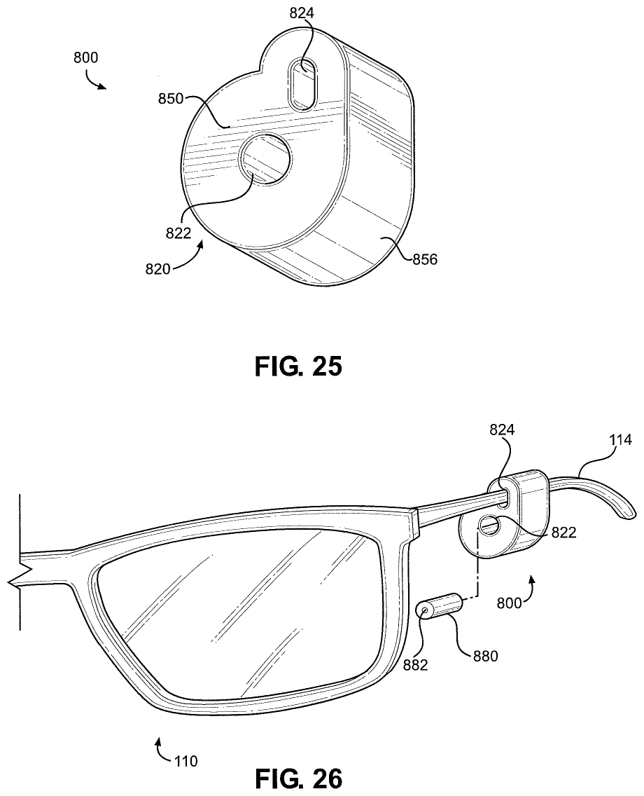

Referring now to FIG. 25 a perspective view of an alternative embodiment of a temple bar cam 800 is formed to have a single continuous bore 824 for receiving a temple bar 114 of a pair of eyeglasses 110. Temple bar cam 800 is formed with a first deformable bore 822 to deform as the temple bar cam 800 is placed against a user's face and formed as a camera receiver which is sized to receive a cylindrical mini-camera (not shown in this Figure).

FIG. 26 illustrates the temple bar cam 800 of FIG. 25 as attached to a temple bar 114 of a pair of eyeglasses 110 and showing an insertable mini-camera 880 with a lens 882 positioned within the continuous bore 822.

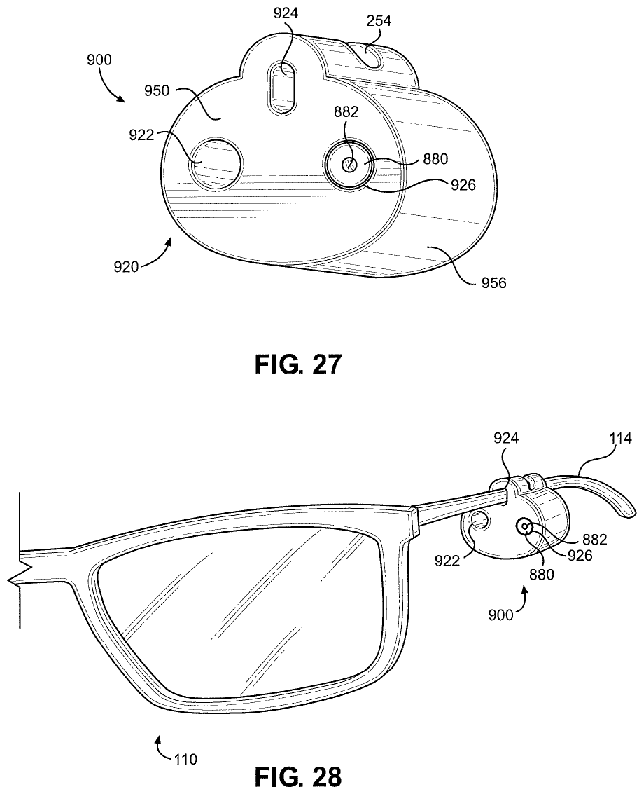

Referring now to FIG. 27 is a perspective view of an alternative embodiment of a temple bar cam 900 having a pair of temple bar receivers 924 separated by aperture 254 for receiving a temple bar 114. Temple bar cam 900 includes a first deformable bore 922 configured to deform as the temple bar cam 900 is placed against a user's face as described above with regard to other embodiments. A second bore 926 is formed as a camera receiver sized to receive a cylindrical mini-camera 880 having a lens 882. In this embodiment, mini-camera 880 is positioned away from the user's face so that the lens 882 of camera 880 has an increased field of view that allows for the camera 880 field of view to avoid the frame of eyeglasses 110. This provides a clear, unobstructed, view forward from the temple bar cam 900.

Referring now to FIG. 28, the temple bar cam 900 of FIG. 27 is shown attached to a temple bar 114 of a pair of eyeglasses 110 and showing an insertable mini-camera 880 positioned within the second continuous bore 926. When in use, continuous bore 922 will deform as the temple bar cam 900 rotates inward and rests against the user's face.

The temple bar cams that have been shown and described herein are illustrative of the present invention. The temple bar cams described herein can be made of any material suitable for the application. It is to be appreciated that the specific materials may vary depending on the required durometer and strength of the particular design, and may include alone or combinations of other materials including but not limited to plastics, metals, or natural products such as wood or cork.

The temple bar cams that have been shown herein have been described without reference to specific dimensions or relative geometries. Specifically, the temple bar cams of the present invention are not limited to the exemplary embodiments presented herein, and the invention extends to scope of the claims below.

While there have been shown what are presently considered to be preferred embodiments of the present invention, it will be apparent to those skilled in the art that various changes and modifications can be made herein without departing from the scope and spirit of the invention.

What is claimed is:

1. An eyeglass support, comprising:
a temple bar cam formed with a temple bar receiver configured to receive a temple bar of a pair of eyeglasses, said temple bar cam configured to rotate longitudinally about said temple bar receiver to contact a user's face to restrain a pair of glasses from downward movement when the temple bar of a pair of glasses is inserted through said temple bar receiver and said glasses are worn by said user.

2. The temple bar cam of claim 1, wherein the temple bar cam comprises medical grade silicone.

3. The temple bar cam of claim 2, wherein the temple bar cam comprises a conical frustum shape.

4. The temple bar cam of claim 3, further comprising a conic bore.

5. The temple bar cam of claim 4, further comprising a lateral surface and a rectangular aperture on the lateral surface proximate the temple bar receiver and extending from the lateral surface to the temple bar receiver.

6. The temple bar cam of claim 5, wherein the temple bar cam assumes a first deformation of the conical frustum shape when a temple bar is passed through the temple bar cam.

7. The temple bar cam of claim 6, wherein the temple bar cam assumes a second deformation of the conical frustum shape when restraining the temple bar from downward movement.

8. A temple bar cam, comprising:
a cam having a conical frustum shape, a top, a base, and a lateral surface;
a conic bore extending from the top to the base, the conic bore centered along the top and the base and having a conical frustum shape; and
a temple bar receiver extending from the top to the base, proximate the lateral surface,
wherein the conic bore is configured to facilitate deformation of the shape of the cam when pressure is formed between the temple bar receiver and an opposing side of the cam, and
wherein the temple bar receiver is considered to receive an eyeglass temple bar such that the cam is caused to rotate as the temple bar is seated against a face of an eyeglass wearer, thereby preventing eyeglass nose pads from resting against a nose of the eyeglass wearer.

9. The temple bar cam as recited in claim 8, further comprising a rectangular shaped aperture, the rectangular shaped aperture extending from the temple bar receiver to a portion of the lateral surface proximate to the temple bar receiver.

10. The temple bar cam as recited in claim 8, wherein the cam comprises silicone rubber.

11. The temple bar cam as recited in claim 10, wherein the silicone rubber comprises medical grade silicone.

12. A glasses support system, comprising:
glasses having a left temple bar and a right temple bar,
a left temple bar cam on the left temple bar, and
a right temple bar cam on the right temple bar.

13. The glasses support system of claim 12, wherein the left temple bar cam and the right temple bar cam comprise medical grade silicone.

14. The glasses support system of claim 12, wherein the left temple bar cam and the right temple bar cam each comprise a conical frustum shape having a base and a top.

15. The glasses support system of claim 14, wherein the left temple bar cam and the right temple bar cam are oriented so that the base of each faces frontward when the glasses are worn.

16. The glasses support system of claim 14, wherein the left temple bar further comprises a conic bore extending from the top of the left temple bar to the base of the left temple bar, and the right temple bar further comprises a conic bore extending from the top of the right temple bar to the base of the right temple bar.

17. The glasses support system of claim 12, wherein the glasses further comprise nose pads, and wherein the left temple bar cam and the right temple bar cam are configured to sustain the glasses in an elevated position in which the nose pads do not touch a nose of a user wearing the glasses.

18. The glasses support system of claim 17, wherein the left temple bar cam and the right temple bar cam each comprise a cam lobe configured to press against a face of the user in order to sustain the glasses in the elevated position.

19. The glasses support system of claim 18, wherein the cam lobe of the left temple bar cam and the cam lobe of the right temple bar came are configured to deform in shape when pressing against the face of the user.

20. The glasses support system of claim 12 wherein the left temple bar cam on the left temple bar, and the right temple bar cam on the right temple bar are each formed with a continuous bore sized to receive a mini camera.
